(19) United States
(12) Patent Application Publication
(10) Pub. No.: US 2017/0322470 A1
(43) Pub. Date: Nov. 9, 2017

(54) LIQUID CRYSTAL DISPLAY DEVICE

(71) Applicant: Sharp Kabushiki Kaisha, Sakai City, Osaka (JP)

(72) Inventors: YOSUKE IWATA, Sakai City (JP); MITSUHIRO MURATA, Sakai City (JP); SATOSHI MATSUMURA, Sakai City (JP)

(21) Appl. No.: 15/527,718

(22) PCT Filed: Nov. 12, 2015
(86) PCT No.: PCT/JP2015/081802

§ 371 Date: May 18, 2017

(30) Foreign Application Priority Data
Nov. 19, 2014 (JP) 2014-234878

(51) Int. Cl. G02F 1/1343; G02F 1/133; G02F 1/1368

(52) U.S. Cl. CPC G02F 1/134363; G02F 1/1368; G02F 1/13439; G02F 1/13306; G02F 2001/134345; G02F 2001/134372

(57) ABSTRACT

The present invention provides a liquid crystal display device that can achieve a wide viewing angle and rapid response. The liquid crystal display device includes: an upper substrate and a lower substrate; and a liquid crystal layer disposed between the upper and lower substrates, the lower substrate including electrodes consisting of a first electrode disposed on the liquid crystal layer side, a second electrode disposed at a position farther from the liquid crystal layer than the first electrode, and a third electrode disposed at a position farther from the liquid crystal layer than the second electrode, the liquid crystal layer containing liquid crystal molecules that are aligned in parallel with the main surfaces of the upper and lower substrates with no voltage applied, the liquid crystal display device being configured to perform a first drive operation utilizing an electric field generated by any of the electrodes, the electric field rotating a first group of the liquid crystal molecules in a plane parallel to the main surfaces and rotating a second group of the liquid crystal molecules in a direction opposite to the rotation direction of the first group of the liquid crystal molecules in the plane parallel to the main surfaces.

### TECHNICAL FIELD

The present invention relates to liquid crystal display devices. Specifically, the present invention relates to a liquid crystal display device that utilizes an electric field generated by electrodes to provide display.

### BACKGROUND ART

Liquid crystal display devices having a configuration including a liquid crystal display element disposed between paired substrates such as glass substrates have characteristics such as a thin profile, lightweight, and low power consumption. These characteristics have made the devices essential to products used in daily life and business, such as automotive navigation systems, electronic books, digital photo frames, industrial equipment, televisions, personal computers, smartphones, and tablet computers. For liquid crystal display devices for use in these applications, various modes have been considered which relate to the electrode arrangement and substrate design for changes in the optical characteristics of the liquid crystal layer.

Recent liquid crystal display devices employ a display mode such as a vertical alignment (VA) mode which aligns liquid crystal molecules having negative anisotropy of dielectric constant in perpendicular to the substrate surfaces, such as a multi-domain vertical alignment (MVA) mode; an in-plane switching (IPS) mode and a fringe field switching (FFS) mode which align liquid crystal molecules having positive or negative anisotropy of dielectric constant in parallel with the substrate surfaces and apply transverse electric fields to the liquid crystal layer.

In particular, the FFS mode is a liquid crystal mode having been used often for smartphones and tablet computers. For example, Patent Literature 1 discloses an FFS-mode liquid crystal display device comprising: a first and a second transparent insulating substrates arranged opposite to each other with a predetermined distance, with a liquid crystal layer including a plurality of liquid crystal molecules interposed between them; a plurality of gate bus lines and data bus lines formed on the first transparent substrate and arranged in a matrix form to define a unit pixel; a thin film transistor formed at the intersection of the gate bus line and the data bus line; a counter electrode disposed in each unit pixel, made of transparent conductor; and a pixel electrode arranged in each unit pixel to generate a fringe field with the counter electrode, being insulated with the counter electrode and made of transparent conductor and including a plurality of upper slits and lower slits symmetrical each other with respect to long side of the pixel with a predetermined tilted angle.

### CITATION LIST

### Patent Literature

### Patent Literature 1: JP 2002-182230 A

### SUMMARY OF INVENTION

### Technical Problem

Patent Literature 1 discloses that the FFS-mode liquid crystal display device has a wide viewing angle and increases the aperture ratio and transmittance which are low in IPS-mode liquid crystal display devices (for example, see FIG. 6 in Patent Literature 1; FIG. 6 in Patent Literature 1 is a plan view illustrating a pixel structure of an FFS-mode liquid crystal display device). The FFS-mode liquid crystal display device disclosed in Patent Literature 1 can utilize electric fields to force the liquid crystal to respond in rise time. However, the liquid crystal display device allows the liquid crystal to respond just by its viscoelasticity without electric fields in decay time, leading to a slow response speed compared with that in a vertical alignment mode. The response performance can therefore still be improved.

One example of the FFS-mode liquid crystal display device of Patent Literature 1 is described with reference to FIGS. 16 and 17. FIGS. 16 and 17 are each a schematic cross-sectional view illustrating a liquid crystal display device having a conventional FFS-mode electrode structure. FIGS. 16 and 17 each illustrate the structure of a liquid crystal display device in which, in a lower substrate 310 including an upper layer electrode (iv) which is an electrode with slits, the upper layer electrode (iv) is disposed on a lower layer electrode (v) which is a planar electrode with an insulating layer 312 in between. The liquid crystal display device obtains a rise response of a liquid crystal molecules by applying constant voltage to the upper layer electrode (iv) (e.g., the voltage applied to the upper layer electrode (iv) may be any value that can produce a potential difference equal to or higher than a threshold value with the lower layer electrode (v) to generate fringe electric fields forcing the liquid crystal molecules to respond; the threshold value means a voltage value that generates an electric field by which the liquid crystal layer is optically changed and thus the display state of the liquid crystal display device is changed), and obtains a decay response by controlling the potential difference between the upper layer electrode (iv) and the lower layer electrode (v) to a value lower than the threshold value so as to stop (weaken) the fringe electric field.

A conventional FFS mode performs switching in rise time by generating a fringe electric field between the FFS electrodes of the lower substrate as described above to rotate the liquid crystal molecules in the vicinity of the lower layer electrode in the same direction in a horizontal plane. Also, this mode performs switching in decay time by stopping the fringe electric field to allow the liquid crystal molecules to move back with its viscoelasticity to the initial alignment.

The electric fields generated to rotate the liquid crystal molecules, however, are weak in some regions of the liquid crystal layer, in which the rotational speed of the liquid crystal molecules is low. At this time, since the liquid crystal molecules are rotated in the same direction, the strain caused by elastic deformation of the liquid crystal in the horizontal plane is small. Such elastic strain unfortunately gives a small restoring force to move the liquid crystal molecules back to the initial alignment when the electric fields are stopped for switching in decay time, resulting in a low response speed. The conventional FFS mode therefore gives a low response speed both in switching in rise time and switching in decay time.

The present invention has been made in view of the above current state of the art, and aims to provide a liquid crystal display device that can achieve a wide viewing angle and rapid response.

### Solution to Problem

The inventors have made various studies on liquid crystal display devices that provide display utilizing electric fields generated by electrodes, and have focused on the electrode structure of the lower substrate. The inventors have then arrived at a configuration of the lower substrate including three layers of electrodes in place of the lower substrate of a conventional FFS-mode liquid crystal display device which includes two layers of electrodes. Thereby, the inventors have completed the present invention. Here, the initial alignment of the liquid crystal molecules is an alignment parallel to the main surfaces of the upper and lower substrates.

The inventors have also arrived at a drive method (first drive method) of driving liquid crystal by varying the voltage applied to a first electrode (e.g., upper layer electrode) while applying constant voltage to a second electrode (e.g., middle layer electrode) and maintaining a third electrode (e.g., lower layer electrode) at 0 V. The inventors have also found a drive method (second drive method) of driving liquid crystal by varying the voltage applied to the second electrode (e.g., middle layer electrode) to 0 V, and have thereby devised a drive mode of switching between the first drive method and the second drive method.

The liquid crystal display device of the present invention is therefore different from the invention disclosed in Patent Literature 1 in that the lower substrate includes at least three layers of electrodes.

One aspect of the present invention may be a liquid crystal display device including: an upper substrate and a lower substrate; and a liquid crystal layer disposed between the upper and lower substrates, the lower substrate including electrodes consisting of a first electrode disposed on the liquid crystal layer side, a second electrode disposed at a position farther from the liquid crystal layer than the first electrode, and a third electrode disposed at a position farther from the liquid crystal layer than the second electrode, the liquid crystal layer containing liquid crystal molecules that are aligned in parallel with the main surfaces of the upper and lower substrates with no voltage applied, the liquid crystal display device being configured to perform a first drive operation utilizing an electric field generated by any of the electrodes, the electric field rotating a first group of the liquid crystal molecules in a plane parallel to the main surfaces and rotating a second group of the liquid crystal molecules in a direction opposite to the rotation direction of the first group of the liquid crystal molecules in the plane parallel to the main surfaces.

The “electric field generated by any of the electrodes” may be any electric field that is generated by at least one electrode selected from the first electrode, the second electrode, and the third electrode. For example, the liquid crystal molecules are preferably rotated by an electric field generated between the first electrode and the second electrode in white display, and by an electric field generated between the second electrode and the third electrode in the opposite direction in black display.

The first group of the liquid crystal molecules means some liquid crystal molecules among the liquid crystal molecules included in the liquid crystal layer. Similarly, the second group of the liquid crystal molecules means some other liquid crystal molecules among the liquid crystal molecules included in the liquid crystal layer.

In the liquid crystal display device of the present invention, the first electrode, the second electrode, and the third electrode are generally electrically separated, and therefore the voltage values applied to these electrodes can be separately controlled. The liquid crystal display device of the present invention preferably has a configuration in which, for example, the lower substrate includes a slit electrode as a second electrode on a third electrode with an insulating layer or similar layer in between, and includes a slit electrode as a first electrode on the second electrode with an insulating layer or similar layer in between.

The liquid crystal display device is preferably configured to perform a drive operation utilizing an electric field generated by any of the electrodes, the electric field rotating the first group of the liquid crystal molecules and the second group of the liquid crystal molecules at different azimuth angles, and producing paired regions with the rotations at different azimuth angles at least twice in one sub-pixel. In other words, the liquid crystal display device of the present invention preferably has a configuration in which the liquid crystal display device is configured to perform the first drive operation utilizing an electric field generated by any of the electrodes, the electric field rotating the liquid crystal molecules such that, in a sub-pixel in a plan view of the main surfaces of the upper and lower substrates, at least two sets of alternating first and second regions are formed, the first region containing the first group of the liquid crystal molecules aligned at a first azimuth angle, the second region containing the second group of the liquid crystal molecules aligned at a second azimuth angle different from the first azimuth angle.

The configuration in which “at least two sets of alternating first and second regions are formed” may be a configuration in which at least two sets of alternating first and second regions are formed in a stripe pattern or in a staggered pattern.

Also, the liquid crystal display device preferably has a configuration in which at least one of the first electrode, the second electrode, and the third electrode includes a slit, and the liquid crystal display device is configured to perform the first drive operation utilizing an electric field generated by any of the electrodes, the electric field rotating the first group of the liquid crystal molecules in a plane parallel to the main surfaces and rotating the second group of the liquid crystal molecules in the direction opposite to the rotation direction of the first group of the liquid crystal molecules in the plane parallel to the main surfaces, in a region overlapping the slit in a plan view of the main surfaces of the upper and lower substrates.

The electric field “rotating the first group of the liquid crystal molecules in a plane parallel to the main surfaces and rotating the second group of the liquid crystal molecules in the direction opposite to the rotation direction of the first group of the liquid crystal molecules in the plane parallel to the main surfaces, in a region overlapping the slit” may be any electric field that, in a plan view of the main surfaces of the upper and lower substrates, rotates the first group of the liquid crystal molecules in the horizontal plane and rotates the second group of the liquid crystal molecules in the direction opposite to the rotation direction of the first group of the liquid crystal molecules in the horizontal plane, in at least one region overlapping one slit. Preferably, the electric field rotates the first group of the liquid crystal molecules in the horizontal plane and rotates the second group of the liquid crystal molecules in the direction opposite to the rotation direction of the first group of the liquid crystal molecules in the horizontal plane, in each region overlapping one slit.

In particular, the liquid crystal display device preferably has a configuration in which the first electrode and the second electrode each include a slit, and the liquid crystal display device is configured to perform the first drive operation utilizing an electric field generated by any of the electrodes, the electric field rotating the first group of the liquid crystal molecules in a plane parallel to the main surfaces and rotating the second group of the liquid crystal molecules in the direction opposite to the rotation direction of the first group of the liquid crystal molecules in the plane parallel to the main surfaces, in a region overlapping the slit of the first electrode in a plan view of the main surfaces of the upper and lower substrates, while the liquid crystal display device is configured to perform the first drive operation utilizing an electric field generated by any of the electrodes, the electric field rotating the first group of the liquid crystal molecules in a plane parallel to the main surfaces and rotating the second group of the liquid crystal molecules in the direction opposite to the rotation direction of the first group of the liquid crystal molecules in the plane parallel to the main surfaces, in a region overlapping the slit of the second electrode in the plan view.

The first electrode preferably includes a slit. The second electrode also preferably includes a slit. In a plan view of the main surfaces of the upper and lower substrates, an extension direction of the first electrode and an extension direction of the second electrode preferably form an angle of 30° or greater but smaller than 90°. In other words, the first electrode and the second electrode each preferably have a linear part, and an extension direction of the linear part of the first electrode and an extension direction of the linear part of the second electrode preferably form an angle of 30° or greater but smaller than 90°.

Here, the extension direction of the slit electrode (slit extension direction) refers to the longitudinal direction of the linear electrode constituting the slit electrode. Similarly, the extension directions of the grid-like electrodes (first and second grid extension directions) refer to the longitudinal directions of first and second linear electrode parts constituting the grid-like electrode. In a conventional FFS-mode liquid crystal display device, a fringe electric field is generated by the FFS electrodes of the lower substrate in rise time, and the liquid crystal molecules are rotated by the fringe electric field in one direction. In contrast, in the liquid crystal display device of the present invention, the lower substrate includes three layers of electrodes and, for example, utilizes an electric field generated between the first electrode and the second electrode in rise time which rotates the liquid crystal molecules in a first region and the liquid crystal molecules in a second region in the opposite directions in the horizontal plane. Also, the liquid crystal display device utilizes an electric field generated between the second electrode and the third electrode in decay time which rotates the liquid crystal molecules in the first region and the liquid crystal molecules in the second region in the directions opposite to the respective rotation directions in rise time in the horizontal plane.

The liquid crystal display device of the present invention may or may not include a liquid crystal-driving electrode in the upper substrate. Still, the liquid crystal display device preferably includes no liquid crystal-driving electrode in the upper substrate. That is, the liquid crystal display device includes a liquid crystal-driving electrode only in the lower substrate.

Although the shape of the third electrode is not particularly limited, the third electrode is, for example, a grid-like electrode in one preferred embodiment of the present invention. In another preferred embodiment of the present invention, the third electrode includes a slit. The third electrode is a planar electrode in yet another preferred embodiment of the present invention.

Preferably, the liquid crystal display device of the present invention is configured to switch between a first drive method of performing the first drive operation, and a second drive method of performing a second drive operation utilizing an electric field generated by any of the electrodes, the electric field rotating the liquid crystal molecules in one direction in a plane parallel to the main surfaces of the upper and lower substrates. Here, rotating the liquid crystal molecules in one direction may be rotating them in substantially one direction. Also, the “electric field generated by any of the electrodes” may be any electric field that is generated by at least one electrode selected from the first electrode, the second electrode, and the third electrode. For example, preferably, the liquid crystal molecules are rotated by an electric field generated between the first electrode and the second electrode in white display, and are rotated by weakening (stopping) the electric field generated between the first electrode and the second electrode in the opposite direction in black display.

The liquid crystal display device of the present invention may have any configuration appropriately including any other components generally used in liquid crystal display devices.

### Advantageous Effects of Invention

The liquid crystal display device of the present invention can achieve a wide viewing angle and rapid response.

### BRIEF DESCRIPTION OF DRAWINGS

FIG. 1 is a schematic plan view illustrating an electrode structure of a pixel and the initial alignment of liquid crystal molecules in a liquid crystal display device of Embodiment 1.

FIG. 2 is a schematic cross-sectional view of a cross section taken along the line a-b in FIG. 1.

FIG. 3 is a schematic cross-sectional view of a cross section taken along the line c-d in FIG. 1.

FIG. 4 is a schematic plan view illustrating the voltages applied to the electrodes and the alignment of liquid crystal molecules in white display provided by a first drive method in Embodiment 1.

FIG. 5 is a schematic plan view illustrating the voltages applied to the electrodes and the alignment of liquid crystal molecules in white display provided by a second drive method in Embodiment 1.

FIG. 6 is a schematic plan view illustrating the voltages applied to the electrodes and the alignment of liquid crystal molecules in black display provided by the first drive method in Embodiment 1.

FIG. 7 is a graph showing the voltage-transmittance (V-T) characteristics of the respective first drive method and second drive method in Embodiment 1.

FIG. 8 is a schematic plan view illustrating the electrode structure of a pixel and the initial alignment of liquid crystal molecules in a liquid crystal display device of Embodiment 2.

FIG. 9 is a schematic plan view illustrating the voltages applied to the electrodes and the alignment of liquid crystal molecules in black display provided by a first drive method in Embodiment 2.

FIG. 10 is a schematic plan view illustrating the voltages applied to the electrodes and the alignment of liquid crystal molecules in white display provided by the first drive method of Embodiment 2.

FIG. 11 is a graph showing the voltage-transmittance (V-T) characteristics of the respective first drive method and second drive method in Embodiment 2.

FIG. 12 is a schematic plan view illustrating the electrode structure of a pixel and the initial alignment of liquid crystal molecules in a liquid crystal display device of Embodiment 3.

FIG. 13 is a schematic plan view illustrating the voltages applied to the electrodes and the alignment of liquid crystal molecules in black display provided by a first drive method in Embodiment 3.

FIG. 14 is a schematic plan view illustrating the voltages applied to the electrodes and the alignment of liquid crystal molecules in white display provided by the first drive method in Embodiment 3.

FIG. 15 is a graph showing the voltage-transmittance (V-T) characteristics of the respective first drive method and second drive method in Embodiment 3.

FIG. 16 is a schematic cross-sectional view illustrating the electrode structure and the initial alignment of the liquid crystal molecules in a liquid crystal display device of Comparative Example 1.

FIG. 17 is a schematic cross-sectional view illustrating the electrode structure and the alignment of the liquid crystal molecules in white display in the liquid crystal display device of Comparative Example 1.

FIG. 18 is a graph showing the normalized transmittance plotted against rise time in Embodiments 1 to 3 and Comparative Example 1.

FIG. 19 is a graph showing the normalized transmittance plotted against decay time in Embodiments 1 to 3 and Comparative Example 1.

### DESCRIPTION OF EMBODIMENTS

The present invention is described in more detail based on the following examples with reference to the drawings. The present invention, however, is not limited to these examples. A pixel as used herein may be a sub-pixel unless otherwise specified. A sub-pixel refers to a region of a single color such as red (R), green (G), blue (B), or yellow (Y). The paired substrates holding a liquid crystal layer in between are also referred to as upper and lower substrates. One of the substrates disposed on the display surface side is also referred to as an upper substrate, and the other of the substrates disposed on the side opposite to the display surface is also referred to as a lower substrate. Also, among the electrodes included in the substrate, an electrode on the display surface side is also referred to as an upper layer electrode, an electrode on the side opposite to the display surface is also referred to as a lower layer electrode, and an electrode between the upper layer electrode and the lower layer electrode is also referred to as a middle layer electrode. Here, the middle layer electrode may be at any position between the upper layer electrode and the lower layer electrode, and does not need to be at the center of the lower substrate.

In the embodiments, the components and parts exerting the same functions are provided with the same reference signs. Also in the drawings, unless otherwise specified, the reference sign (i) indicates a slit electrode in the upper layer (on the liquid crystal layer side) of the lower substrate, the reference sign (ii) indicates a slit electrode in the middle layer of the lower substrate, the reference sign (iii) indicates a grid-like electrode in the lower layer (on the side opposite to the liquid crystal layer) of the lower substrate, the reference sign (iiia) indicates a planar electrode in the lower layer of the lower substrate, the reference sign (iiib) indicates a slit electrode in the lower layer of the lower substrate, the reference sign (iv) indicates an upper layer electrode in an electrode layer having an FFS structure, and the reference sign (v) indicates a lower layer electrode in an electrode layer having an FFS structure. Also, the dashed double-sided arrow in the drawing (FIG. 17) indicates an electric line of force. The drawings do not illustrate layers such as color filters and a black matrix which are irrelevant to liquid crystal control utilizing electric fields.

The “electrode of the lower substrate” as used herein is at least one of the upper layer electrode (i), the middle layer electrode (ii), and the lower layer electrodes (iii), (iiia) and (iiib).

The slit electrode as used herein is an electrode including a slit, and usually includes plural linear electrode parts. Examples of the slit include a region in which no linear electrode is formed. The planar electrode may have a structure in which electrodes in the respective pixels are independent from each other, or a structure in which electrodes in pixels are electrically connected, for example. The structure in which electrodes in pixels are electrically connected may be, for example, a structure in which electrodes in all the pixels are electrically connected, or a structure in which electrodes in pixels on the same line are electrically connected. In particular, the structure in which electrodes in all the pixels are electrically connected is preferred. Also, the term “planar” may refer to any shape considered to be a planar shape in the art of the present invention. The “planar” electrode may include alignment control structures such as ribs or slits in some regions thereof or may include the alignment control structures in the center portion of a pixel in a plan view of the main surfaces of the substrates. Still, suitable is a planar electrode substantially without alignment control structures.

The term “rise time” herein means the period during which the display state shifts from a dark state (black display) to a bright state (white display). The term “decay time” herein means the period during which the display state shifts from a bright state (white display) to a dark state (black display). The initial alignment of the liquid crystal means the alignment of liquid crystal molecules with no voltage applied (in black display).

The upper layer electrode (i), the middle layer electrode (ii), and the lower layer electrode (iii), (iiia), or (iiib) can usually be set at different electric potentials producing voltage equal to or higher than the threshold voltage. The term “threshold voltage” herein means the voltage giving a transmittance of 5%, with the transmittance in the bright state being defined as 100%. The condition of “being set at different electric potentials producing voltage equal to or higher than the threshold voltage” may be any condition enabling driving at electric potentials that produce voltage equal to or higher than the threshold voltage. This condition enables suitable control of electric fields applied to the liquid crystal layer. A configuration that can provide different electric potentials may be, for example, in the case that the upper layer electrode (i) is a pixel electrode and the middle layer electrode (ii) and lower layer electrode (iii) are common electrodes, an alternating-current (AC) drive configuration in which the liquid crystal is driven by applying alternating-current voltage (AC voltage) produced by varying the voltage to the upper layer electrode (i) using a thin-film transistor (TFT) connected thereto while applying alternating-current voltage to the middle layer electrode (ii) and the lower layer electrodes (iii), (iiia), or (iiib) using another TFT; an alternating-current drive configuration in which the liquid crystal is driven by applying alternating-current voltage to the middle layer electrode (ii) and the lower layer electrodes (iii), (iiia), or (iiib) commonly connected in each pixel line or in all the pixels, using a TFT corresponding to the line or all the pixels; or a direct-current (DC) drive configuration in which the liquid crystal is driven by applying direct-current voltage (DC voltage) to the middle layer electrode (ii) and the lower layer electrode (iii), (iiia), or (iiib) without using a TFT.

### Embodiment 1

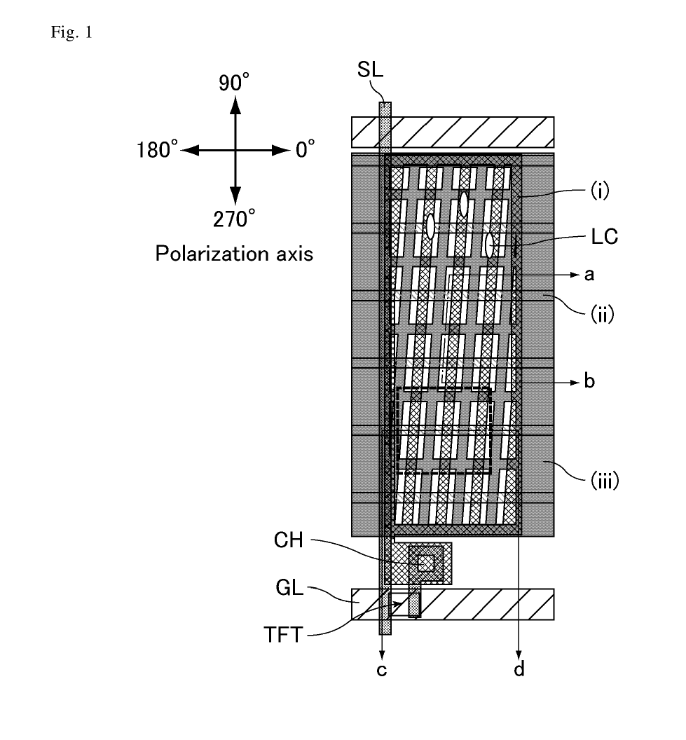

FIG. 1 is a schematic plan view illustrating an electrode structure of a pixel and the initial alignment of liquid crystal molecules in a liquid crystal display device of Embodiment 1.

The upper layer electrode (i) includes linear electrode parts in a plan view of the main surfaces of the substrates. The linear electrode parts are substantially parallel to each other, and are separated by slits substantially parallel to each other. Such an embodiment in which the upper layer electrode (i) includes a slit is one preferred embodiment of the present invention.

The middle layer electrode (ii) also includes linear electrode parts in a plan view of the main surfaces of the substrates. The linear electrode parts are substantially parallel to each other, and are separated by slits substantially parallel to each other.

Such an embodiment in which the middle layer electrode (ii) includes a slit is one preferred embodiment of the present invention.

In this manner, the upper layer electrode (i) and the middle layer electrode (ii) each preferably include a linear part.

The structures of the upper layer electrode (i) and the middle layer electrode (ii) illustrated in FIG. 1 are merely examples, and the electrodes may have any of various structures.

The extension direction of the slits in the upper layer electrode (i) and the extension direction of the slits in the middle layer electrode (ii) form an angle of 88°. In other words, the two slit electrodes of the lower substrate are disposed such that the extension directions thereof cross each other at an angle of 88° in a plan view of the main surfaces of the substrates. The angle is preferably 30° or greater but smaller than 90°, more preferably 45° or greater, still more preferably 60° or greater, particularly preferably 75° or greater. Such an electrode structure can further shorten both the rise response time and the decay response time.

In the upper layer electrode (i), an electrode width L of each linear part is 3 μm, and an electrode space S between adjacent linear parts is 6 μm. The electrode width L is preferably in the range of 2 μm to 7 μm, for example. The electrode space S is preferably in the range of 2 μm to 14 μm, for example. The ratio (L/S) of the electrode width L and the electrode space S is preferably 0.1 to 1.5. The lower limit of the ratio L/S is more preferably 0.2, while the upper limit thereof is more preferably 0.8.

In the middle layer electrode (ii), the electrode width L of each linear part is 3 μm, and the electrode space S between adjacent linear parts is 11 μm. The electrode width L is preferably in the range of 2 μm to 7 μm. The electrode space S is preferably in the range of 3 μm to 18 μm. The ratio (L/S) of the electrode width L and the electrode space S is preferably 0.01 to 2.5. The lower limit of the ratio L/S is more preferably 0.05, still more preferably 0.1, particularly preferably 0.15. Also, the upper limit of the ratio L/S is more preferably 2, still more preferably 1, particularly preferably 0.4.

The electrode widths L of the upper layer electrode (i) are usually substantially the same in a pixel, and the electrode spaces S thereof are usually substantially the same in a pixel. If the electrode widths L are different in a pixel, one of the widths is preferably in the above range, and all the widths are more preferably in the above range. Also, if the electrode spaces S are different in a pixel, one of the spaces is preferably in the above range, and all the spaces are more preferably in the above range. The same shall apply to the middle layer electrode (ii).

The lower layer electrode (iii) of the lower substrate is a grid-like electrode. The first grid extension direction and the second grid extension direction of the lower layer electrode (iii) are respectively parallel to the slit extension direction of the upper layer electrode (i) and the slit extension direction of the middle layer electrode (ii). The “grid-like electrode” refers to an electrode having a shape in which the spaced first linear electrode parts and the spaced second linear electrode parts cross each other.

In FIG. 1, the first linear electrode parts of the lower layer electrode (iii) of the lower substrate are arranged between the linear electrode parts of the upper layer electrode (i). The dimensions such as the electrode width and the electrode space of the first linear electrode parts are the same as the dimensions such as the electrode width and the electrode space of the linear parts of the upper layer electrode (i). The second linear electrode parts of the lower layer electrode (iii) of the lower substrate are arranged between the linear electrode parts of the middle layer electrode (ii). The dimensions such as the electrode width and the electrode space of the second linear electrode parts are the same as the dimensions such as the electrode width and the electrode space of the linear parts of the middle layer electrode (ii).

The electrodes (upper layer electrode (i), middle layer electrode (ii), and lower layer electrode (iii)) in the layers are in the positional relationship illustrated in FIG. 1. Such an embodiment in which the upper layer electrode and the middle layer electrode of the lower substrate each include a slit and the lower layer electrode of the lower substrate is a grid-like electrode is one preferred embodiment of the present invention.

Embodiment 1 employs two linear polarizers having the respective polarization axes illustrated in FIG. 1. In Embodiment 1, one linear polarizer is disposed on the outer side (on the side opposite to the liquid crystal layer) of each of the upper and lower substrates. The linear polarizers are disposed in crossed Nicols, with the polarization axes of the linear polarizers of the upper and lower substrates being perpendicular or parallel to the long axes of liquid crystal molecules (i.e., the azimuth at which the liquid crystal molecules are initially aligned). As described above, the upper and lower substrates each preferably include a linear polarizer.

The upper layer electrode (i) is electrically connected to the drain electrode extending from the corresponding thin-film transistor TFT through a contact hole CH. The liquid crystal display device applies, at a timing selected by a gate bus line GL, the voltage supplied from a source bus line SL to the upper layer electrode (i) designed to drive the liquid crystal via the thin film transistor TFT.

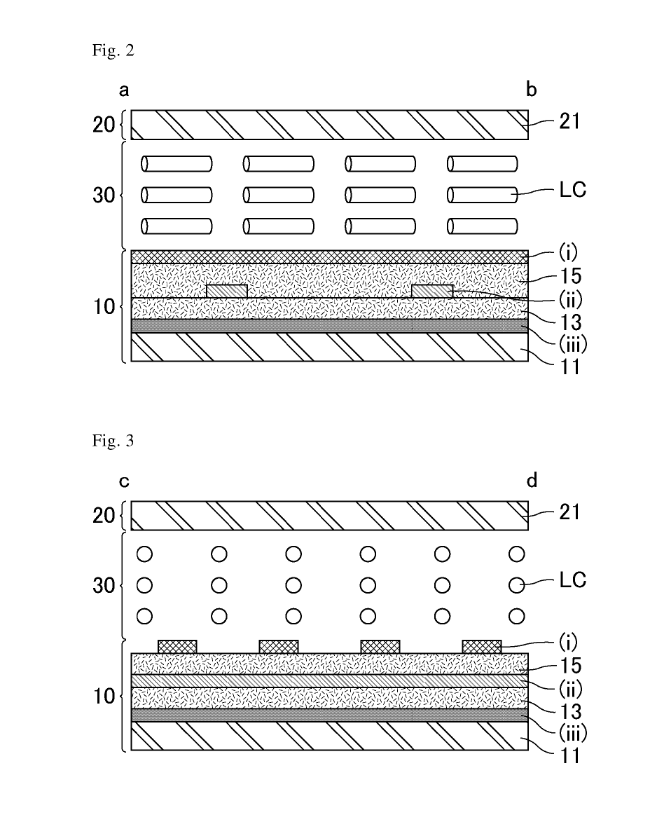

FIG. 2 is a schematic cross-sectional view of a cross section taken along the line a-b in FIG. 1. FIG. 3 is a schematic cross-sectional view of a cross section taken along the line c-d in FIG. 1.

The liquid crystal display device of Embodiment 1 has a configuration including, as illustrated in FIG. 2 and FIG. 3, a lower substrate 10, a liquid crystal layer 30, and an upper substrate 20 in the given order from the back side to the viewer side of the liquid crystal display device.

The liquid crystal display device of Embodiment 1, as illustrated in FIG. 2 and FIG. 3, horizontally aligns the liquid crystal molecules LC when the potential difference between the electrodes of the upper and lower substrates is lower than the threshold voltage.

The lower layer electrode (iii) of the lower substrate 10 is a grid-like electrode as described above, and the middle layer electrode (ii), which is a slit electrode, is disposed thereon with an insulating layer 13 in between. On the middle layer electrode (ii) is disposed the upper layer electrode (i), which is a slit electrode, with an insulating layer 15 in between. A liquid crystal-driving electrode is not provided to the upper substrate 20, and is provided only to the lower substrate 10.

The insulating layer 13 and the insulating layer 15 each have a dielectric constant of 6.9 and an average thickness of 0.3 μm. The insulating layer 13 and the insulating layer 15 each are a nitride film SiN, but may be an oxide film SiO₂, an acrylic rein, or a combination of these materials.

The upper and lower substrates each includes a horizontal alignment film (not illustrated) on the liquid crystal layer side which is designed to horizontally align liquid crystal molecules with no voltage applied such that the long axis of each liquid crystal molecule is at an azimuth angle of 90°. The horizontal alignment film may be any film that horizontally aligns the liquid crystal molecules with respect to its surface, such as an alignment film made of an organic material or inorganic material, a photoalignment film made of a photoactive material, and an alignment film on which alignment treatment has been performed by a technique such as rubbing. The alignment film may be an alignment film on which the alignment treatment by a technique such as rubbing has not been performed. An alignment film for which alignment treatment is not necessary, such as an alignment film made of an organic or inorganic material or a photoalignment film, can achieve simplification of the process, leading to reduction of the cost as well as increase in reliability and in yield. The rubbing treatment may unfortunately cause liquid crystal contamination with impurities from the rubbing cloth or due to some other factor, point defects due to foreign substances, and display unevenness due to non-uniform rubbing in the liquid crystal panel. Alignment films for which alignment treatment is not necessary can also avoid such disadvantages.

The liquid crystal includes liquid crystal molecules that are aligned in parallel with the main surfaces of the substrates with no voltage applied. The state of being “aligned in parallel with the main surfaces of the substrates” may be any state in which the liquid crystal molecules are regarded as being substantially aligned in parallel with the main surfaces of the substrates in the art of the present invention and optical effects can be achieved. It is suitable that the liquid crystal substantially consists of liquid crystal molecules that are aligned in parallel with the main surfaces of the substrates with no voltage applied. The state of being “with no voltage applied” may be any state in which voltage is substantially regarded as being not applied in the art of the present invention. Such horizontal alignment liquid crystal is advantageous in achieving characteristics such as a wide viewing angle.

In the liquid crystal display device of Embodiment 1, the liquid crystal layer 30 is made of a liquid crystal material having positive anisotropy of dielectric constant (anisotropy of dielectric constant Δ∈=5.9, refractive index Δn=0.11). Such an embodiment in which the liquid crystal layer contains liquid crystal molecules having positive anisotropy of dielectric constant is one preferred embodiment of the present invention. Liquid crystal molecules having positive anisotropy of dielectric constant can be aligned in a certain direction by the electric fields generated, enabling easy alignment control and more rapid response. The liquid crystal preferably has an anisotropy of dielectric constant Δ∈ of 3 or more, more preferably 4 or more, still more preferably 5 or more. The anisotropy of dielectric constant Δ∈ of the liquid crystal herein refers to a value measured by an LCR meter.

In Embodiment 1, the liquid crystal layer 30 has an average thickness (cell gap) d_{LC} of 3.2 μm.

The average thickness d_{LC} of the liquid crystal layer herein means a thickness calculated by averaging the thicknesses of the entire liquid crystal layer in the liquid crystal display device.

The value of d_{LC}×Δn is preferably 100 nm or greater, more preferably 150 nm or greater, still more preferably 200 nm or greater. Also, the value of d_{LC}× Δn is preferably 550 nm or smaller, more preferably 500 nm or smaller, still more preferably 450 nm or smaller.

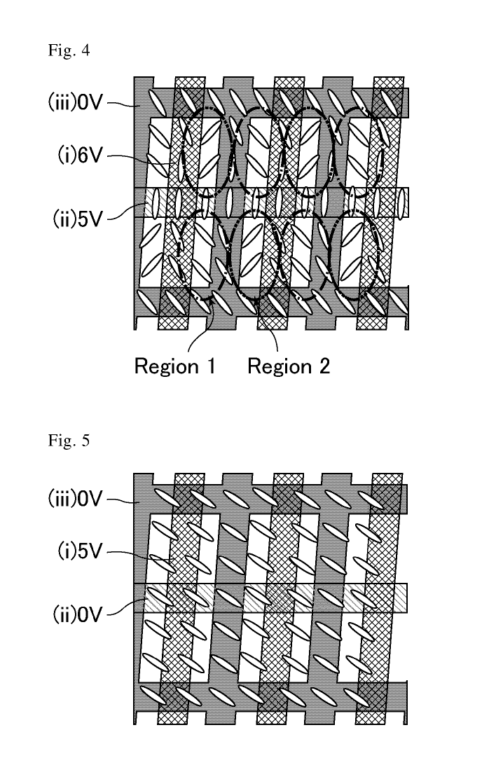

FIG. 4 is a schematic plan view illustrating the voltages applied to the electrodes and the alignment of liquid crystal molecules in white display provided by a first drive method in Embodiment 1. FIG. 5 is a schematic plan view illustrating the voltages applied to the electrodes and the alignment of liquid crystal molecules in white display provided by a second drive method in Embodiment 1. FIG. 4 and FIG. 5 each are a plan view of the portion surrounded by a dashed line in FIG. 1.

In the liquid crystal display device of Embodiment 1, the lower layer electrode (iii), which is a grid-like electrode, is always at 0 V, while the voltage applied to the upper layer electrode (i), which is a slit electrode, is varied as described below. At this time, different alignment states can be achieved by different methods of driving the liquid crystal, namely a method of applying constant voltage (in FIG. 4, 5 V) to the middle layer electrode (ii), which is the other slit electrode (first drive method) and a method of setting the voltage of the middle layer electrode (ii) to 0 V (second drive method).

Here, the voltage applied to the upper layer electrode (i) in white display (maximum transmittance) was 6 V in the case of the first drive method as indicated in FIG. 4, and was 5 V in the case of the second drive method as indicated in FIG. 5 to give the maximum transmittance in the present embodiment.

In the first drive method, the liquid crystal molecules are rotated at different azimuth angles alternately in the horizontal plane. That is, the liquid crystal molecules are rotated counterclockwise in the horizontal plane in a region 1 surrounded by a chain line in FIG. 4, while the liquid crystal molecules are rotated clockwise in the horizontal plane in a region 2 surrounded by a two-dot chain line. In other words, in a plan view of the upper and lower substrates, the liquid crystal molecules are rotated in two different directions, not in one direction, in the horizontal plane between the linear electrode parts of the upper layer electrode (i) (in a region overlapping a slit of the upper layer electrode (i)) and between the linear electrode parts of the middle layer electrode (ii) (in a region overlapping a slit of the middle layer electrode (ii)). This is because application of a voltage of 5 V to the middle layer electrode (ii) causes the middle layer electrode (ii) to generate with the upper layer electrode (i) an electric field that rotates the liquid crystal molecules at different azimuth angles alternately in the horizontal plane.

The constant application of voltage to the middle layer electrode (ii) results in generation of a strong electric field in the entire region in the horizontal plane in rise response time. Thereby, rapid rise response is achieved.

In white display provided by the first drive method, the electric potentials of the electrodes of the lower substrate are set such that the liquid crystal molecules are rotated at different azimuth angles alternately in the horizontal plane between the upper layer electrode (i) and the middle layer electrode (ii). Specifically, as described above, the electric potential of the upper layer electrode (i) is set to 6 V and the electric potential of the middle layer electrode (ii) is set to 5 V such that the potential difference between the upper layer electrode (i) and the middle layer electrode (ii) is 1 V. The potential difference between the upper layer electrode (i) and the middle layer electrode (ii) may be any value equal to or lower than 8 V, for example, and is preferably 5 V or lower.

The potential difference between the middle layer electrode (ii) and the lower layer electrode (iii) is preferably in the range of 2 to 8 V, more preferably in the range of 3 to 7 V.

Meanwhile, in the second drive method, as illustrated in FIG. 5, the liquid crystal molecules are rotated in the same direction in the entire region to be in an alignment state similar to that in the FFS mode. This is because in the case that the voltages applied to the middle layer electrode (ii) and the lower layer electrode (iii) are the same (in FIG. 5, 0 V), only an electric field that rotates the liquid crystal molecules in one direction is generated as in the case of the FFS mode.

The potential difference between the middle layer electrode (ii) and the lower layer electrode (iii) may be any value lower than the threshold voltage.

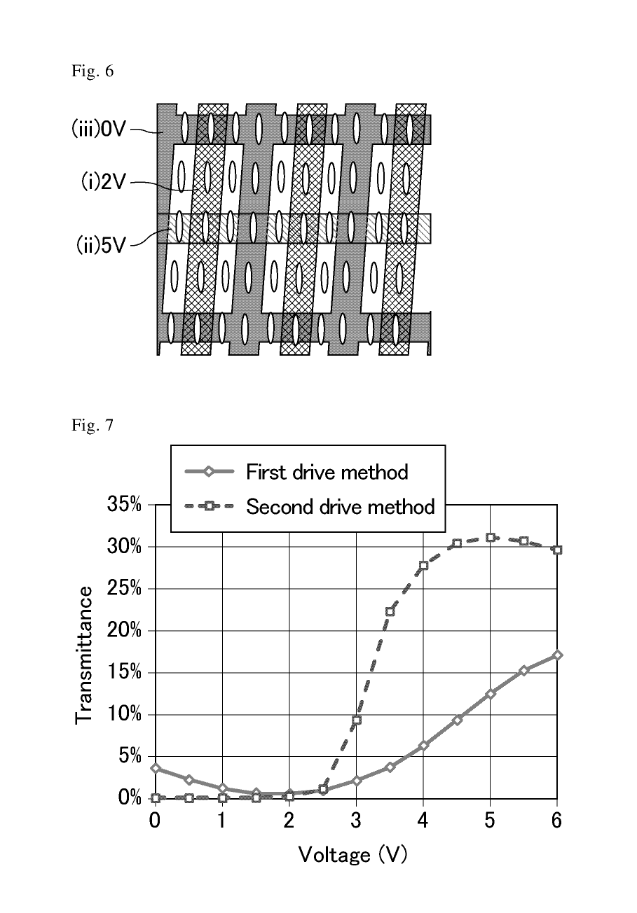

FIG. 6 is a schematic plan view illustrating the voltages applied to the electrodes and the alignment of liquid crystal molecules in black display provided by the first drive method in Embodiment 1. FIG. 6 is a plan view of the portion surrounded by the dashed line in FIG. 1.

In the first drive method, since voltage (in FIG. 6, 5 V) is applied constantly to the middle layer electrode (ii) also in decay response time, stopping (weakening) the voltage applied to the upper layer electrode (i) allows the electric field generated between the middle layer electrode (ii) and the lower layer electrode (iii) to forcibly rotate the liquid crystal molecules back in the direction of the initial alignment. Also in the case of the first drive method, bend alignment and splay alignment are generated in the horizontal plane which induce elastic strain to produce a great restoring force. Thereby, rapid decay response is also achieved. The first drive method produces at least two sets of alternating regions, namely regions containing the liquid crystal molecules rotated at one azimuth angle in a plane and regions containing the liquid crystal molecules rotated at a different azimuth angle in the plane. In this manner, at least two sets of alternating regions, namely regions containing the liquid crystal molecules rotated at one azimuth angle in a plane and regions containing the liquid crystal molecules rotated at a different azimuth angle in the plane, are preferably formed.

In FIG. 6, the electric potential of the upper layer electrode (i) is set to 2 V. As described above, the voltage applied to the pixel electrode (in Embodiment 1, the upper layer electrode (i)) is decreased from the voltage giving the maximum transmittance or may be stopped, while the values such as the electric potentials of the other electrodes (in Embodiment 1, the middle layer electrode (ii) and the lower layer electrode (iii)) can be the same as those in white display provided by the first drive method, and the preferred ranges thereof are the same as those in white display provided by the first drive method. For example, in Embodiment 1, the electric potential of the middle layer electrode (ii) of the lower substrate is set to 5 V and the electric potential of the lower layer electrode (iii) is set to 0 V both in white display and black display. The liquid crystal display device of the present invention therefore preferably keep the constant voltages of the respective middle layer electrode (ii) and lower layer electrode (iii) of the lower substrate both in white display and black display.

The voltage application method employed in the first drive method is varying the voltage applied to the upper layer electrode (i), which is a pixel electrode, applying constant voltage to the middle layer electrode (ii), and setting the voltage of the lower layer electrode (iii) to 0 V. Such a voltage application method is one preferred embodiment for the liquid crystal display device of the present invention. Still, as long as the effects of the present invention are achieved, the top-down positional relationship between the electrodes may appropriately be changed.

FIG. 7 is a graph showing the voltage-transmittance (V-T) characteristics of the respective first drive method and second drive method in Embodiment 1. The voltages indicated are the voltages applied to the upper layer electrode (i).

The effect of switching from the first drive method to the second drive method on increase in the transmittance was analyzed by calculating the voltage-transmittance (V-T) characteristics of the first drive method and the second drive method in Embodiment 1 with an LCD Master 3D. The analysis found that the maximum transmittance (31.2%) achieved by the second drive method was 1.82 times higher than the maximum transmittance (17.1%) achieved by the first drive method, and switching from the first drive method to the second drive method successfully increased the transmittance.

Accordingly, the first drive method in Embodiment 1 can generate an electric field rotating the liquid crystal molecules at different azimuth angles alternately in the horizontal plane and increase the response speed both in rise time and decay time, thereby achieving both a wide viewing angle and rapid response. The second drive method can generate an electric field that rotates the liquid crystal molecules in the same direction in the entire region as in the case of the FFS mode, thereby achieving both a wide viewing angle and a high transmittance.

In Embodiment 1, the lower substrate included three layers of electrodes. Such an embodiment in which the electrodes of the lower substrate consist of an electrode including a slit in the upper layer, an electrode including a slit in the middle layer, and an electrode such as a grid-like electrode on the side opposite to the liquid crystal layer is one preferred embodiment of the liquid crystal display device of the present invention. Still, since any liquid crystal display device employing the first drive method to generate an electric field can achieve the effects of the present invention, the upper layer electrode (i) and/or the middle layer electrode (ii) of the lower substrate may not be a slit electrode and may be paired comb electrodes, for example. In the case of using paired comb electrodes, the liquid crystal molecules are rotated in the horizontal plane by a transverse electric field generated between the paired comb electrodes. The relation between the alignment direction of the liquid crystal molecules and the electrode positions may be determined by replacing the extension directions of the slit electrodes in the FFS electrodes with the extension directions of the paired comb electrodes.

The thin-film transistors in the liquid crystal display device of Embodiment 1 are preferably oxide semiconductor thin-film transistors in order to achieve higher transmittance. An oxide semiconductor has higher carrier mobility than amorphous silicon. Accordingly, the area occupied by such a transistor in one pixel can be reduced, so that the aperture ratio can be increased. Thereby, a higher light transmittance per pixel can be achieved. Hence, use of oxide semiconductor TFTs can provide a more significant effect of achieving a higher transmittance, which is an effect of the present invention. This means that the lower substrate preferably includes thin film transistors which preferably contain an oxide semiconductor.

The upper and lower substrates in the liquid crystal display device of Embodiment 1 are usually paired substrates that are designed to hold liquid crystal in between. The substrates are produced by, for example, forming components such as conductive lines, electrodes, and color filters on insulating substrates (bases) made of a material such as glass or resin.

The liquid crystal display device of Embodiment 1 can appropriately include components (e.g. light sources) which are included in a common liquid crystal display device. Also, the liquid crystal display device of Embodiment 1 is preferably configured to drive the liquid crystal by the active matrix driving. The same shall apply to the embodiments described later.

### Embodiment 2

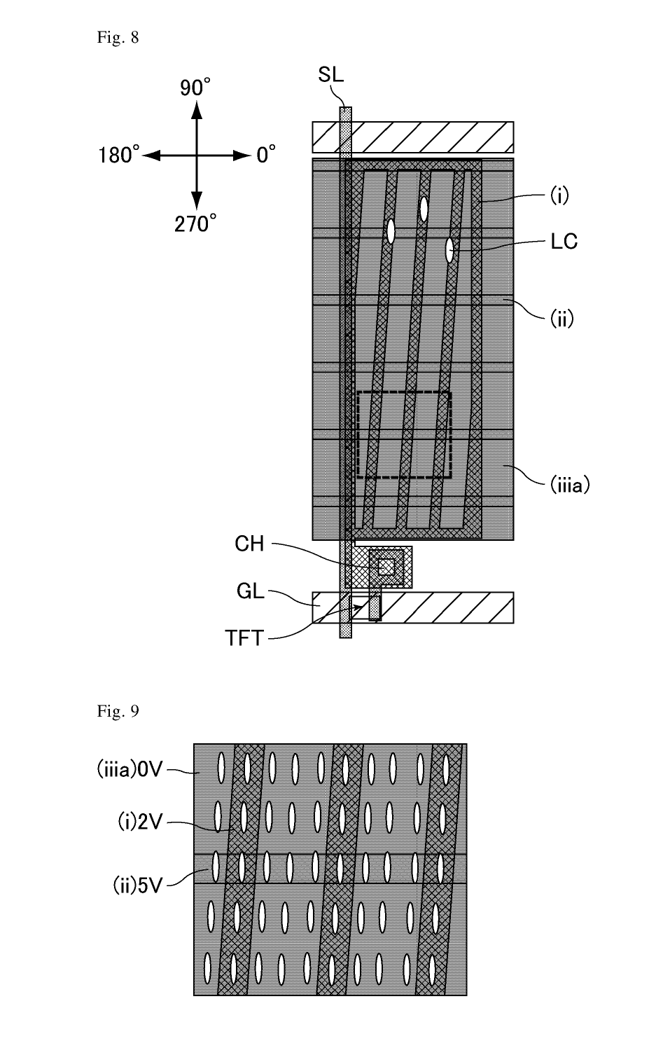

FIG. 8 is a schematic plan view illustrating the electrode structure of a pixel and the initial alignment of liquid crystal molecules in a liquid crystal display device of Embodiment 2.

While the lower layer electrode (iii) of the lower substrate was designed to have a grid-like pattern in Embodiment 1, the lower layer electrode (iiia) of the lower substrate was designed to be a planar electrode in Embodiment 2. The preferred configuration and voltage application method in Embodiment 2 except for the shape of the lower layer electrode (iiia) are the same as the preferred configuration and voltage application method in Embodiment 1.

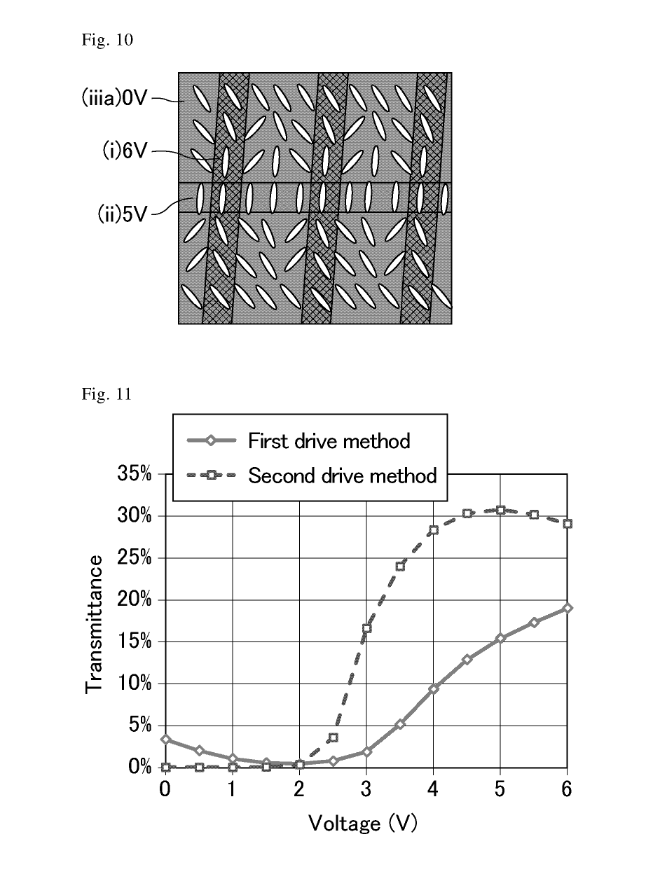

FIG. 9 is a schematic plan view illustrating the voltages applied to the electrodes and the alignment of liquid crystal molecules in black display provided by a first drive method in Embodiment 2. FIG. 10 is a schematic plan view illustrating the voltages applied to the electrodes and the alignment of liquid crystal molecules in white display provided by the first drive method of Embodiment 2. FIG. 9 and FIG. 10 each are a plan view of the portion surrounded by the dashed line in FIG. 8.

Both in black display and white display, the voltage of the lower layer electrode (iiia), which is a planar electrode, is always at 0 V and the voltage applied to the upper layer electrode (i), which is a slit electrode, is varied. At this time, constant voltage (in FIG. 9 and FIG. 10, 5 V) is applied to the middle layer electrode (ii), which is the other slit electrode, for driving (first drive method). Also, the voltage applied to the upper layer electrode (i) in black display was at 2 V. The voltage applied to the upper layer electrode (i) in white display (maximum transmittance) was at 6 V.

In the first drive method, the liquid crystal molecules are rotated at different azimuth angles alternately in the horizontal plane. This is because application of a voltage of 5 V to the middle layer electrode (ii) causes the middle layer electrode (ii) to generate with the upper layer electrode (i) an electric field that rotates the liquid crystal molecules at different azimuth angles alternately in the horizontal plane.

The constant application of voltage to the middle layer electrode (ii) results in generation of a strong electric field in the entire region in the horizontal plane in rise response time. Thereby, rapid rise response is achieved.

In the first drive method, since voltage (in FIG. 10, 5 V) is applied constantly to the middle layer electrode (ii) also in decay response time, stopping (weakening) the voltage applied to the upper layer electrode (i) allows the electric field generated between the middle layer electrode (ii) and the lower layer electrode (iiia) to forcibly rotate the liquid crystal molecules back in the direction of the initial alignment. Also in the case of the first drive method, bend alignment and splay alignment are generated in the horizontal plane which induce elastic strain to produce a greater restoring force. Thereby, rapid decay response is also achieved.

In the case of driving the liquid crystal by setting the voltage applied to the middle layer electrode (ii) to 0 V, only an electric field that rotates the liquid crystal molecules in one direction is generated as in the case of Embodiment 1, so that the same alignment state as in the FFS mode can be achieved (second drive method).

FIG. 11 is a graph showing the voltage-transmittance (V-T) characteristics of the respective first drive method and second drive method in Embodiment 2.

Also in Embodiment 2, the effect of switching from the first drive method to the second drive method on increase in the transmittance was analyzed by calculating the V-T characteristics of the first drive method and the second drive method with an LCD Master 3D. The analysis found that in Embodiment 2, the maximum transmittance (30.8%) achieved by the second drive method was 1.62 times higher than the maximum transmittance (19.0%) achieved by the first drive method, and switching from the first drive method to the second drive method successfully increased the transmittance.

Accordingly, the first drive method in the configuration of Embodiment 2 can also generate an electric field rotating the liquid crystal molecules at different azimuth angles alternately in the horizontal plane and increase the response speed both in rise time and decay time, thereby achieving both a wide viewing angle and rapid response. The second drive method can generate an electric field that rotates the liquid crystal molecules in the same direction in the entire region as in the case of the FFS mode, thereby achieving both a wide viewing angle and a high transmittance.

### Embodiment 3

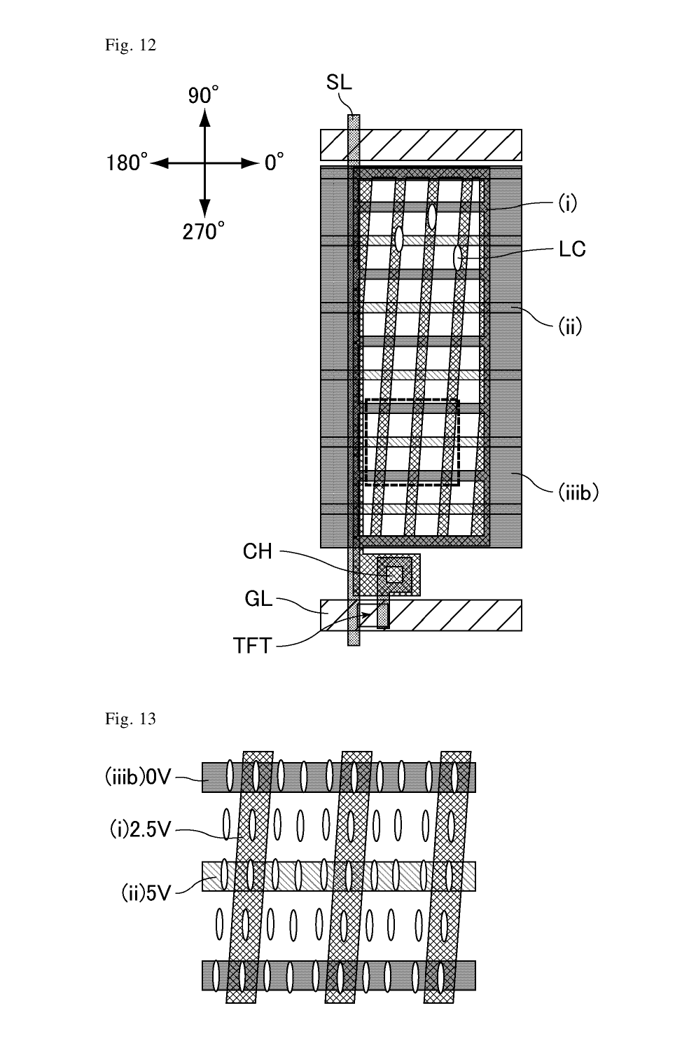

FIG. 12 is a schematic plan view illustrating the electrode structure of a pixel and the initial alignment of liquid crystal molecules in a liquid crystal display device of Embodiment 3.

While the lower layer electrode (iii) of the lower substrate was designed to have a grid-like pattern in Embodiment 1, the lower layer electrode (iiib) of the lower substrate was designed to be a slit electrode in Embodiment 3. The preferred configuration and voltage application method in Embodiment 3 except for the shape of the lower layer electrode (iiib) of the lower substrate are the same as the preferred configuration and voltage application method in Embodiment 1.

The lower layer electrode (iiib) of the lower substrate includes linear electrode parts in a plan view of the main surfaces of the substrates. The linear electrode parts are substantially parallel to each other, and are separated by slits substantially parallel to each other. Such an embodiment in which the lower layer electrode (iiib) includes a slit is one preferred embodiment of the present invention. Also, the linear electrode parts of the lower layer electrode (iiib) are arranged between the linear electrode parts of the middle layer electrode (ii).

The structures of the upper layer electrode (i), the middle layer electrode (ii), and the lower layer electrode (iiib) illustrated in FIG. 12 are merely examples, and the electrodes may be slit electrodes having any of various structures.

The extension direction of the slits in the lower layer electrode (iiib) is parallel to the extension direction of the slits in the middle layer electrode (ii).

In the lower layer electrode (iiib), the electrode width L of each linear part is 3 μm, and the electrode space S between adjacent linear parts is 11 μm. The electrode width L is preferably in the range of 2 μm to 7 μm. The electrode space S is preferably in the range of 3 μm to 18 μm. The ratio (L/S) of the electrode width L and the electrode space S is preferably 0.01 to 2.5. The lower limit of the ratio L/S is more preferably 0.05, still more preferably 0.1, particularly preferably 0.15. Also, the upper limit of the ratio L/S is more preferably 2, still more preferably 1, particularly preferably 0.4.

The electrode widths L of the lower layer electrode (iiib) are usually substantially the same in a pixel, and the electrode spaces S thereof are usually substantially the same in a pixel, as in the case of the upper layer electrode (i) and the middle layer electrode (ii). If the electrode widths L are different in a pixel, one of the widths is preferably in the above range, and all the widths are more preferably in the above range. Also, if the electrode spaces S are different in a pixel, one of the spaces is preferably in the above range, and all the spaces are more preferably in the above range.

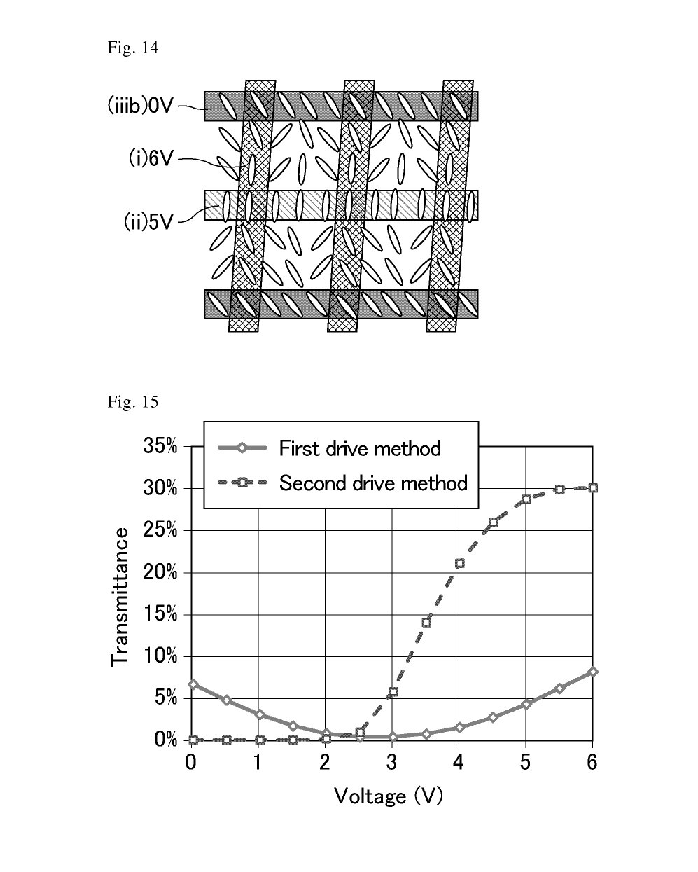

FIG. 13 is a schematic plan view illustrating the voltages applied to the electrodes and the alignment of liquid crystal molecules in black display provided by a first drive method in Embodiment 3. FIG. 14 is a schematic plan view illustrating the voltages applied to the electrodes and the alignment of liquid crystal molecules in white display provided by the first drive method in Embodiment 3. FIG. 13 and FIG. 14 each are a plan view of the portion surrounded by the dashed line in FIG. 12.

Both in black display and white display, the voltage of the lower layer electrode (iiib), which is a slit electrode, is set always to 0 V and the voltage applied to the upper layer electrode (i), which is a slit electrode, is varied. At this time, constant voltage (in FIG. 13 and FIG. 14, 5 V) is applied to the middle layer electrode (ii), which is the other slit electrode, for driving the liquid crystal (first drive method). Also, the voltage applied to the upper layer electrode (i) in black display was set to 2.5 V. The voltage applied to the upper layer electrode (i) in white display (maximum transmittance) was set to 6 V.

In the first drive method, the liquid crystal molecules are rotated at different azimuth angles alternately in the horizontal plane. This is because application of a voltage of 5 V to the middle layer electrode (ii) causes the middle layer electrode (ii) to generate with the upper layer electrode (i) an electric field that rotates the liquid crystal molecules at different azimuth angles alternately in the horizontal plane.

The constant application of voltage to the middle layer electrode (ii) results in generation of a strong electric field in the entire region in the horizontal plane in rise response time. Thereby, rapid rise response is achieved.

In the first drive method, since voltage (in FIG. 14, 5 V) is applied constantly to the middle layer electrode (ii) also in decay response time, stopping (weakening) the voltage applied to the upper layer electrode (i) allows the electric field generated between the middle layer electrode (ii) and the lower layer electrode (iiib) to forcibly rotate the liquid crystal molecules back in the direction of the initial alignment. Also in the case of the first drive method, bend alignment and splay alignment are generated in the horizontal plane which induce elastic strain to produce a greater restoring force. Thereby, rapid decay response is also achieved.

In the case of setting the voltage applied to the middle layer electrode (ii) to 0 V, only an electric field that rotates the liquid crystal molecules in one direction is generated as in the case of Embodiments 1 and 2, so that the same alignment state as in the FFS mode can be achieved (second drive method).

FIG. 15 is a graph showing the voltage-transmittance (V-T) characteristics of the respective first drive method and second drive method in Embodiment 3.

Also in Embodiment 3, the effect of switching from the first drive method to the second drive method on increase in the transmittance was analyzed by calculating the V-T characteristics of the first drive method and the second drive method with an LCD Master 3D. The results are shown in FIG. 15. The analysis found that the maximum transmittance (30.1%) achieved by the second drive method was 3.67 times higher than the maximum transmittance (8.2%) achieved by the first drive method, and switching from the first drive method to the second drive method in Embodiment 3 also successfully increased the transmittance as in Embodiment 2.

Accordingly, the first drive method in the configuration of Embodiment 3 can also generate an electric field rotating the liquid crystal molecules at different azimuth angles alternately in the horizontal plane and increase the response speed both in rise time and decay time, thereby achieving both a wide viewing angle and rapid response. The second drive method can generate an electric field that rotates the liquid crystal molecules in the same direction in the entire region as in the case of the FFS mode, thereby achieving both a wide viewing angle and a high transmittance.

The different shapes of the lower layer electrodes cause the lower layer electrodes to generate slightly different electric fields with another electrode. As a result, the voltage applied to the upper layer electrode (i) in the first drive method which gave the lowest transmittance and thereby achieved favorable black display was 2 V in Embodiments 1 and 2 and 2.5 V in Embodiment 3 (see FIG. 7, FIG. 11, FIG. 15).

### Comparative Example 1

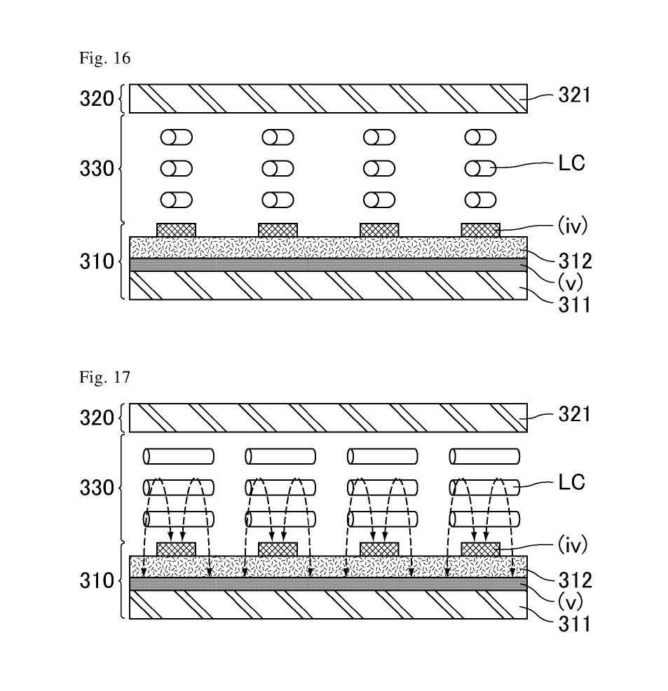

FIG. 16 is a schematic cross-sectional view illustrating the electrode structure and the initial alignment of the liquid crystal molecules in a liquid crystal display device of Comparative Example 1. FIG. 16 is also a schematic cross-sectional view illustrating one example of the electrode structure of a conventional FFS-mode liquid crystal display device.

In Comparative Example 1, the lower layer electrode (v) of a lower substrate 310 is a planar electrode, and an upper layer electrode (iv), which is a slit electrode, is disposed thereon with an insulating layer 312 in between. A liquid crystal-controlling electrode is not provided to an upper substrate 320.

The upper and lower substrates each included a horizontal alignment film (not illustrated) on the liquid crystal layer side which was designed to horizontally align the liquid crystal molecules with no voltage applied such that the azimuth angle of each molecule was 7° from the slit extension direction of the upper layer electrode (iv). Also, the upper and lower substrates each included a polarizer (not illustrated) on the side opposite to the liquid crystal layer. The polarizers used were linear polarizers, and they were disposed in crossed Nicols, with the polarization axes of the polarizers of the upper and lower substrates being perpendicular or parallel to the long axes of liquid crystal molecules. The liquid crystal material and the thickness thereof were the same as those in Embodiment 1. In the upper layer electrode (iv), the electrode width L of each linear part is 3.0 μm, and the electrode space S between adjacent linear parts is 6.0 μm. The dielectric constant of the insulating layer 312 is 6.9, and the average thickness thereof is 0.3 μm. The other configurations of the liquid crystal display device of Comparative Example 1, such as the liquid crystal material and the average thickness of the liquid crystal layer 330, are the same as those of the corresponding components in the liquid crystal display device of Embodiment 1.

FIG. 17 is a schematic cross-sectional view illustrating the electrode structure and the alignment of the liquid crystal molecules in white display in the liquid crystal display device of Comparative Example 1.

The liquid crystal display device of Comparative Example 1 performs switching in rise time by generating a fringe electric field between the upper layer electrode (iv) and the lower layer electrode (v) of the lower substrate to rotate the liquid crystal molecules in the vicinity of the lower layer electrode in the same direction in a horizontal plane. Also, the liquid crystal display device performs switching in decay time by stopping the fringe electric field to allow the liquid crystal molecules to move back with its viscoelasticity to the initial alignment.

The electric fields generated to rotate the liquid crystal molecules, however, are weak in some regions of the liquid crystal layer, in which the rotational speed of the liquid crystal molecules is low. At this time, since the liquid crystal molecules are rotated in the same direction, the strain caused by elastic deformation of the liquid crystal in the horizontal plane is small. Such elastic strain unfortunately gives a small restoring force to move the liquid crystal molecules back to the initial alignment when the electric fields are stopped for switching in decay time, resulting in a low response speed. This liquid crystal display device therefore gives a low response speed both in switching in rise time and switching in decay time.

### <Comparison of Response Performance in Embodiments 1 to 3 and Comparative Example 1>

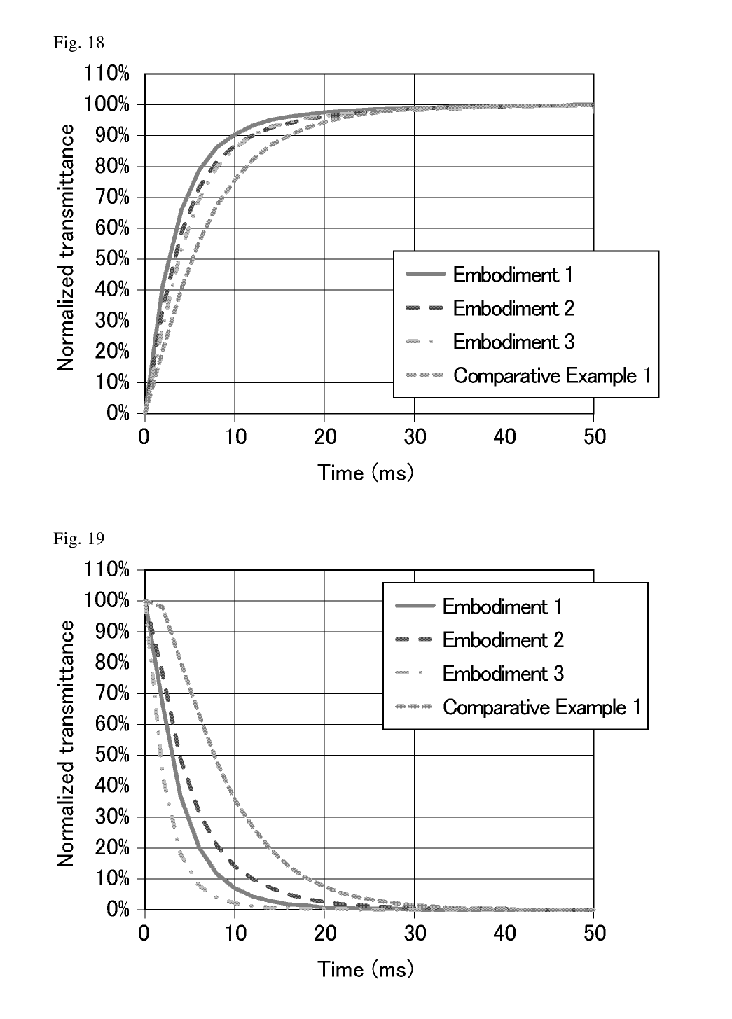

FIG. 18 is a graph showing the normalized transmittance plotted against rise time in Embodiments 1 to 3 and Comparative Example 1. FIG. 19 is a graph showing the normalized transmittance plotted against decay time in Embodiments 1 to 3 and Comparative Example 1.

The effect on increase in response speed was analyzed by calculating the response waveforms in the embodiments and the comparative example with an LCD Master 3D available from Shintech, Inc. The simulation conditions (e.g., electrode configuration, applied voltage, liquid crystal properties) in the embodiments and the comparative example are as described herein. The same shall apply to the later-described embodiments and comparative examples.

The effect on increase in response speed was analyzed by calculating the response waveforms in the first drive methods in Embodiments 1 to 3 and Comparative Example 1 with the LCD Master 3D. FIG. 18 and FIG. 19 respectively show the rise response waveform in the case of applying the voltages for white display indicated in FIG. 4 to the respective electrodes in the configuration of Embodiment 1, and the decay response waveform in the case of applying the voltages for black display indicated in FIG. 6 to the respective electrodes in the configuration of Embodiment 1. FIG. 18 and FIG. 19 also respectively show the rise response waveform in the case of applying the voltages for white display indicated in FIG. 10 to the respective electrodes in the configuration of Embodiment 2, and the decay response waveform in the case of applying the voltages for black display indicated in FIG. 9 to the respective electrodes in the configuration of Embodiment 2. FIG. 18 and FIG. 19 also respectively show the rise response waveform in the case of applying the voltages for white display indicated in FIG. 14 to the respective electrodes in the configuration of Embodiment 3, and the decay response waveform in the case of applying the voltages for black display indicated in FIG. 13 to the respective electrodes in the configuration of Embodiment 3. FIG. 18 and FIG. 19 also respectively show the rise response waveform in the case of applying a voltage of 5 V which is white voltage (the white voltage means voltage that gives the maximum transmittance) to the upper layer electrode (iv) illustrated in FIGS. 16 and 17 and applying a voltage of 0 V to the lower layer electrode (v) in the FFS mode of Comparative Example 1, and the decay response waveform in the case of weakening the electric potential of the upper layer electrode (iv) in the FFS mode of Comparative Example 1.

The rise response time it is defined as the time during which the transmittance changes from 10% to 90%, and the decay response time τd is defined as the time during which the transmittance changes from 90% to 10%. Based on these definitions, the time τr+τd in each of the first drive methods in Embodiments 1 to 3 and Comparative Example 1 is shown in Table 1.

The display mode of the liquid crystal display device in each example is normally black in which black display corresponds to a gray scale value of 0 and white display corresponds to a gray scale value of 255, with a greater gray scale value indicating a higher voltage applied to the liquid crystal layer. The luminance is normalized by taking the normalized transmittance at a gray scale value of 255 as 100%.

TABLE 1

| | τr + τd |
|---|---|
| | (ms) |
| Embodiment 1 | 17.3 |
| Embodiment 2 | 22.4 |
| Embodiment 3 | 16.4 |
| Comparative | 30.1 |
| Example 1 | |

Table 1 shows that the times τr+τd in the first drive methods of Embodiments 1 to 3 were all shorter than the time τr+τd in Comparative Example 1, and thus shows that the first drive methods in Embodiments 1 to 3 had an effect on increase in the response speed.

The liquid crystal display devices of the present embodiments described above can perform the first drive method achieving rapid response which cannot be achieved by a conventional FFS mode. Also, the liquid crystal display devices can perform the second drive method which can achieve as high a transmittance as that of the conventional FFS-mode liquid crystal display device. Here, the liquid crystal display device of the present invention may be any liquid crystal display device that can perform at least the first drive method.

The liquid crystal display devices of the present embodiments described above can provide display by appropriately switching between the first drive method and the second drive method. Also, the liquid crystal display devices can provide the desired display by appropriately combining white display and black display in each drive method.

The liquid crystal display device of the present invention preferably includes a controller configured to perform the first drive method, more preferably a controller configured to perform driving by switching between the first drive method and the second drive method. Switching between the drive methods enables achievement of a wide viewing angle, rapid response, and a high transmittance.

Thereby, the liquid crystal display device can satisfy all of these characteristics, namely rapid response, a wide viewing angle, and a high transmittance, with one electrode configuration.

Also, the liquid crystal display device of the present invention preferably includes a controller that automatically switches between the first drive method and the second drive method under a given condition. The controller is preferably one that includes a temperature sensor, for example, and is configured to automatically switch between the first drive method and the second drive method based on the temperature. For example, the controller is preferably one configured to perform the second drive method achieving a high transmittance at temperatures which do not cause a problem of a low response speed (for example, in the temperature range with a lower limit of −20° C. to 20° C.), while performing the first drive method achieving rapid response at low temperatures which cause a problem of a low response speed (for example, the temperature range with an upper limit of −20° C. to 20° C.). Thereby, the liquid crystal display device can achieve the desired effects more properly.

In addition, the liquid crystal display device of the present invention may include a controller configured to switch between the first drive method and the second drive method in accordance with the instructions by the user.

The present invention may encompass methods for driving a liquid crystal display device utilizing the above-described liquid crystal display device.

In the case of alternating-current drive of the liquid crystal by applying alternating-current voltage to only one of the electrodes (the upper layer electrode (i) in the above embodiments) of the lower substrate as in the liquid crystal display device of the present invention, the circuits, drivers, and conductive lines for alternating-current drive may be provided to only the above electrode of the lower substrate as in the conventional manner. Accordingly, compared with a liquid crystal display device including the circuits, drivers, and conductive lines for alternating-current drive in both the lower substrate and the upper substrate in order to apply alternating-current voltage to both the electrode(s) of the lower substrate and the electrode(s) of the upper substrate to perform the alternating-current drive, the liquid crystal display device of the present invention has significantly high degree of freedom in driving.

Examples of the liquid crystal display device of the present invention include in-vehicle units (e.g., automotive navigation systems), electronic books, digital photo frames, industrial equipment, televisions, personal computers, smartphones, and tablet computers. The present invention is preferably applied to devices used at both high temperatures and low temperatures, such as in-vehicle units (e.g., automotive navigation systems).

The details of the liquid crystal display device of the present invention, such as the electrode structure, can be confirmed by microscopic observation of the lower substrate with a device such as a scanning electron microscope (SEM).

### REFERENCE SIGNS LIST

(i): upper layer electrode
(ii): middle layer electrode
(iii), (iiia), (iiib): lower layer electrode
(iv): upper layer electrode
(v): lower layer electrode
CH: contact hole
TFT: thin-film transistor
SL: source bus line
GL: gate bus line
LC: liquid crystal molecule
10, 310: lower substrate
11, 21, 311, 321: glass substrate
13, 15, 312: insulating layer
20, 320: upper substrate
30, 330: liquid crystal layer

1. A liquid crystal display device comprising:
an upper substrate and a lower substrate; and
a liquid crystal layer disposed between the upper and lower substrates,
the lower substrate including electrodes consisting of a first electrode disposed on the liquid crystal layer side, a second electrode disposed at a position farther from the liquid crystal layer than the first electrode, and a third electrode disposed at a position farther from the liquid crystal layer than the second electrode,
the liquid crystal layer containing liquid crystal molecules that are aligned in parallel with the main surfaces of the upper and lower substrates with no voltage applied,
the liquid crystal display device being configured to perform a first drive operation utilizing an electric field generated by any of the electrodes, the electric field rotating a first group of the liquid crystal molecules in a plane parallel to the main surfaces and rotating a second group of the liquid crystal molecules in a direction opposite to the rotation direction of the first group of the liquid crystal molecules in the plane parallel to the main surfaces.

2. The liquid crystal display device according to claim 1,
wherein the liquid crystal display device is configured to perform the first drive operation utilizing an electric field generated by any of the electrodes, the electric field rotating the liquid crystal molecules such that, in a sub-pixel in a plan view of the main surfaces of the upper and lower substrates, at least two sets of alternating first and second regions are formed, the first region containing the first group of the liquid crystal molecules aligned at a first azimuth angle, the second region containing the second group of the liquid crystal molecules aligned at a second azimuth angle different from the first azimuth angle.

3. The liquid crystal display device according to claim 1 or 2,
wherein at least one of the first electrode, the second electrode, and the third electrode includes a slit, and
the liquid crystal display device is configured to perform the first drive operation utilizing an electric field generated by any of the electrodes, the electric field rotating the first group of the liquid crystal molecules in a plane parallel to the main surfaces and rotating the second group of the liquid crystal molecules in the direction opposite to the rotation direction of the first group of the liquid crystal molecules in the plane parallel to the main surfaces, in a region overlapping the slit in a plan view of the main surfaces of the upper and lower substrates.

4. The liquid crystal display device according to claim 1,
which is configured to switch between
a first drive method of performing the first drive operation, and
a second drive method of performing a second drive operation utilizing an electric field generated by any of the electrodes, the electric field rotating the liquid crystal molecules in one direction in a plane parallel to the main surfaces of the upper and lower substrates.

5. The liquid crystal display device according to claim 1,
wherein the first electrode includes a slit.

6. The liquid crystal display device according to claim 1,
wherein the second electrode includes a slit.

7. The liquid crystal display device according to claim 6,
wherein in a plan view of the main surfaces of the upper and lower substrates, an extension direction of the first electrode and an extension direction of the second electrode form an angle of 30° or greater but smaller than 90°.

8. The liquid crystal display device according to claim 1,
wherein the third electrode is a grid-like electrode.

9. The liquid crystal display device according to claim 1,
wherein the third electrode includes a slit.

10. The liquid crystal display device according to claim 1,
wherein the third electrode is a planar electrode.

11. The liquid crystal display device according to claim 1,
wherein the liquid crystal molecules have positive anisotropy of dielectric constant.

12. The liquid crystal display device according to claim 1,
wherein the lower substrate includes a thin-film transistor, and
the thin-film transistor contains an oxide semiconductor.
